(19) United States
(12) Patent Application Publication
(10) Pub. No.: US 2007/0106690 A1
(43) Pub. Date: May 10, 2007

(54) Personalized memory album

(76) Inventors: Vanessa S. Denniston, Greenville, SC (US); Duff B. Wagner, Taylors, SC (US)

Correspondence Address: MILLIKEN & COMPANY, PO BOX 1926, SPARTANBURG, SC, 29303, US

(21) Appl. No.: 11/269,224

(22) Filed: Nov. 8, 2005

(51) Int. Cl. G06F 17/00

(52) U.S. Cl. 707/104.1

(57) ABSTRACT

This invention relates to a process to create a personalized memory album including selecting image elements comprising a directed image supplied by a software program, a personalized image, and personalized text, uniting the selected image elements into a collected image file, previewing the collected image file, printing the collected image file onto the requisite number of fabric media sheets and, assembling the printed fabric media sheets and project base components into a personalized memory album.

### TECHNICAL FIELD

This invention relates to a method of making album. More particularly, the invention relates to a method of making a personalized memory album using elements from software combined with user imputed elements.

### BACKGROUND

Most individuals value certain memories above others, and given the frail nature of human memory, desire aids which can help them retain and supplement these particularly valued memories. One traditional means of doing this has been the use of photo albums, which provide a means of organizing and preserving photographs capturing various visual scenes.

Collection and retention of memorabilia items has long been a favorite hobby of many individuals. Photo albums have been extensively used for retaining photographs on photo album pages by positioning photographs in specially provided pockets, retaining photographs between a firm page and a transparent cover, by engaging corners of the photographs in mounted brackets attached to the photo album page and by other similar means.

In recent years, collectors and hobbyists have been using the so-called “scrapbooks” for retaining objects that have monetary or purely sentimental value. Some of the items retained in the scrapbook pages may be collectibles that have historic value, such as invitations to important political functions, concert tickets, letters from notable individuals and the like. However, majority of the individuals uses scrapbooks for retaining items of purely sentimental value, such as photographs, wedding invitations, graduation announcements, etc.

The covers of the albums are preprinted with an image or plain and the pages that are incorporated into the scrapbooks are usually blank, allowing the user to display the items in any desired order on the page. There is a need for the user to customize not only the inside pages of a scrapbook, but personalize the covers of the memory album also.

### SUMMARY OF THE INVENTION

The present invention provides advantages and/or alternatives over the prior art by providing a process for producing a personalized memory album comprising in order the steps of selecting image elements (a directed image, a personalized image, and personalized text), uniting the selected image elements into a collected image file, previewing the collected image file, printing the collected image file onto the requisite number of fabric media sheets, and assembling the personalized memory album.

### BRIEF DESCRIPTION OF THE DRAWINGS

The accompanying drawings which are incorporated in and which constitute a part of this specification illustrate several exemplary constructions and procedures in accordance with the present invention and, together with the general description of the invention given above and the detailed description set forth below, serve to explain the principles of the invention wherein:

FIG. 1 is a flow chart representing the steps to create the memory album.

FIG. 2 is an illustration of a theme and a pattern selected from the software package.

FIG. 3 is an illustration collected image file of a theme and a pattern selected from the software package with all inputted personalized image and text elements.

FIG. 4a is an illustration of a printed outer front cover with the collected image file.

FIG. 4b is an illustration of a cover half.

FIG. 4c is an illustration of a printed inner front cover.

FIG. 5a is an illustration of a cover half positioned on the adhesive side of the outer front cover sheet before the outer front cover flaps are folded over the cover half.

FIG. 5b is an illustration of a cover half positioned on the adhesive side of the outer front cover sheet after the outer front cover flaps are folded over the cover half.

FIG. 6 is an illustration of the inside of the cover half after applying the outer front cover sheet, applying the inner front cover sheet, and placing holes in the inner and outer cover sheet to match up with corresponding holes in the cover half.

FIG. 7 is a cross-sectional view of a completed memory album.

FIGS. 8a-8c are illustrations of extra graphics.

### DETAILED DESCRIPTION OF THE INVENTION

The invention relates to a method of making a personalized memory album. It combines elements from a software package and inputs from the user, to form collected image files. These files are printed out onto fabric media sheets and combined with other album components to form a personalized memory album. The memory album may be sold as a craft kit. The craft kits may include a CD with a software package, fabric media sheets, and project base components.

The software will run on a computer and will direct activities for organizing and printing images. The software package guides the user through the steps to create and print the collected image file. The software package is preferably on a CD, but may also be on the internet or in any other computer storage medium.

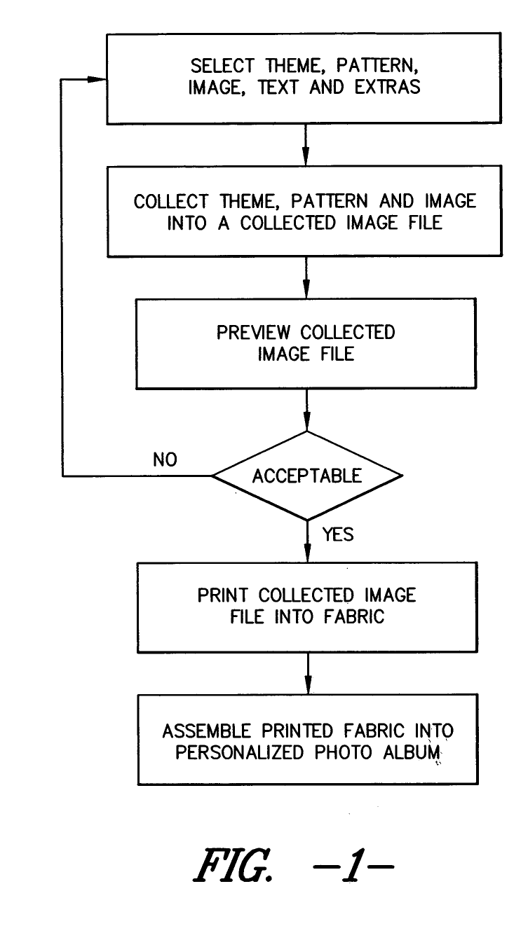

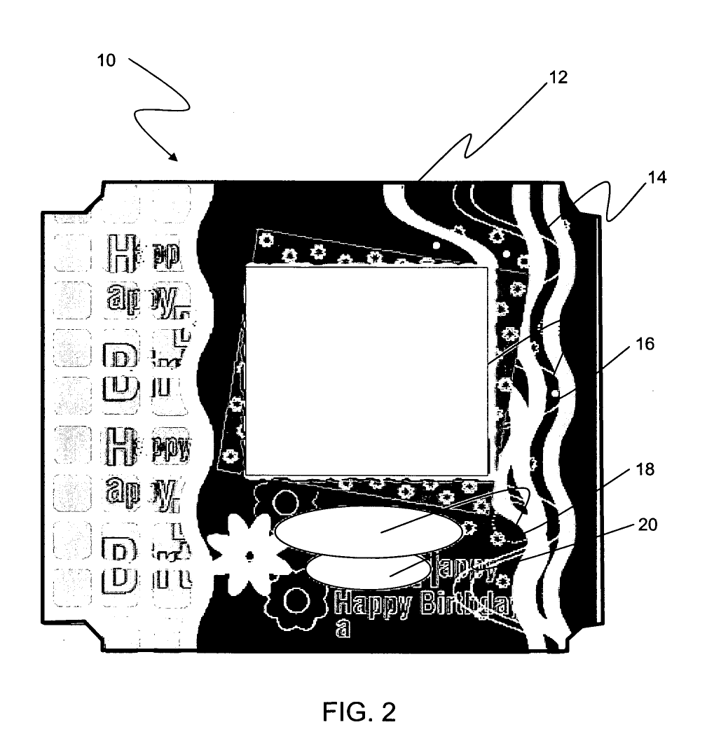

FIG. 1 shows flow chart representing the steps to create the memory album. The method for producing a memory album begins with the user selecting image elements (theme, pattern, image, text, and additional graphics) to create a directed image. One element of the directed image is a theme for the memory album. The user selects a theme for the memory album from the predetermined themes in the software package. Some examples of themes include birthdays, anniversaries, births, holidays, and vacations. After selecting a theme, the user selects a pattern from a set of patterns related to the theme selected. The patterns include background graphics and different predetermined layouts for personalized text and images. The background graphics include a cutting line 12 as part of the background so that during assembly of the memory album, the user cuts along this line to assemble the covers. The pattern determines where each of the personalized images, text, and additional graphics will be located on the album covers. The patterns vary and may have one or multiple images or text locations depending on the pattern selected. FIG. 2 shows an illustration of a pattern selected form a set of patterns related to the theme of birthdays. The pattern 10 displayed on the computer screen has a background graphic 14, a cutting line 12, a predetermined location for an image 16, and predetermined locations for text 18 and 20.

As part of selecting image elements, the user inputs personalized images and text. Preferably, when the user inputs personalized text, the user also selects the font and the size of the text to control the look of the personalized text. In one embodiment, the software has a “what-you-see-is-what-you-get” viewing window on the display to show the user what the text with the personalized words, size, and font, will look like on the final product.

The personalized image(s) may be supplied by the user or provided by the software. If the image is supplied by the user, the image is in a typical computer image format and may come from any source including the internet, a digital camera, or scanner. Preferably, the software also has stock images in which the user can select as the personalized image(s).

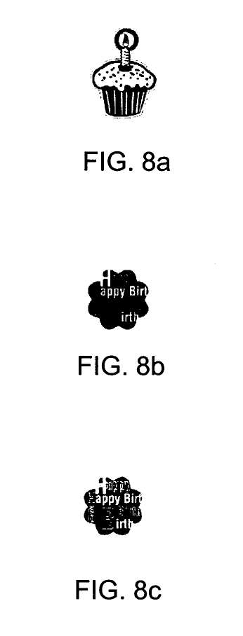

The user may select the personalized images, text, theme, and pattern in any order. The selected image elements may also include additional graphics, either provided by the software or the user. Preferably, the user may also select additional graphics to include in the memory album. Some examples of additional graphics may be found in FIGS. 8a-c. Sometimes these additional graphics may be referred to as “fun extras” and may include graphics, cartoons, additional images, borders, or text. These fun extras may also be printed separately on additional fabric media sheets to be used in the middle pages of the memory album.

The user may also embellish the album to further personalize the album. The user may add double sided clear adhesive tape and then apply clear, holeless beads to the tape to create a 3-D effect on the covers, additional graphics, and/or middle pages. Other addenda may be added to the covers or middle pages of the album include but not limited to glitter, holographic images, lenticular images, and puff paint. The memory album may also include one or more tie members or ribbons extending from its cover to tie the memory album closed.

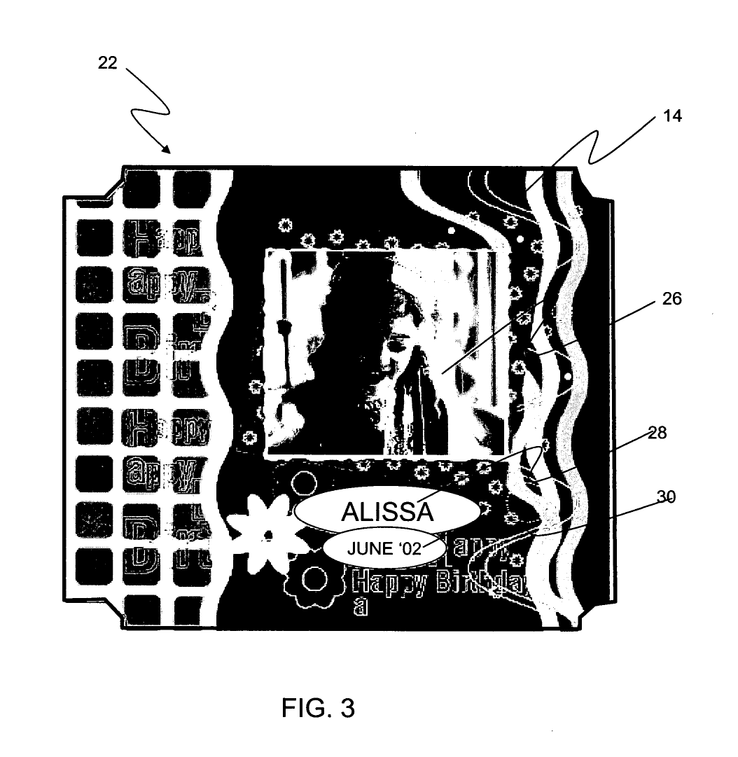

Once the user has selected all of the selected image elements, the software program unites all of the elements into a collected image file. This file may be any graphical computer file but is preferably a portable document file (.pdf) type file. It may also be a .jpg (lossy compressed 24 bit color image storage format developed by the Joint Photographic Experts Group), .bmp (bitmap), or tiff (tagged image file format). The user previews this file to ensure that the elements selected are correct and then the user prints the collected image file on the requisite number of fabric media sheets. If the user is not satisfied with the preview of the collected image file, the user can go back and change some or all of the selected image elements, text, theme, or pattern. FIG. 3 shows an illustration of the collected image file 22 as would be shown on the computer. The collected image file 22 has a background graphic 14, a personalized image 26, and personalized text 28 and 30.

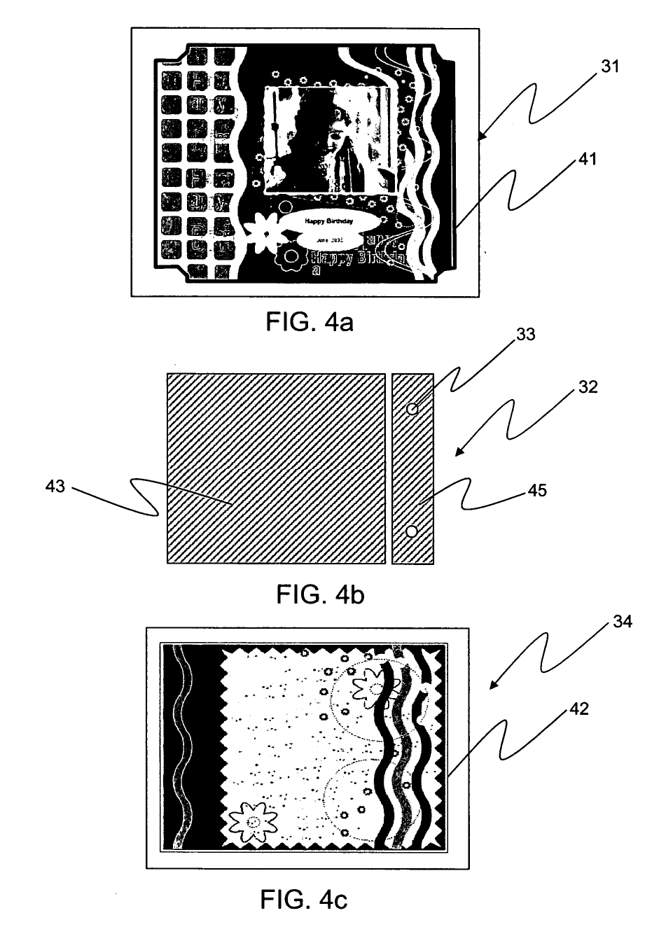

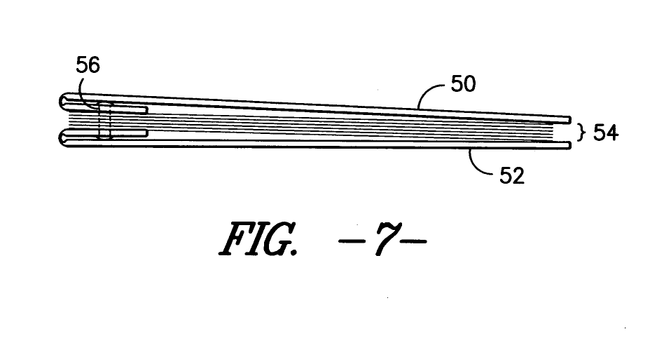

If the user is satisfied with the collected image file preview, the collected image file is printed onto the requisite number of fabric media sheets. The printed collected image file for the outer front cover is shown as FIG. 4a and the collected image file for the inner front cover is shown as FIG. 4c. The printing is preferably inkjet printing, but could be any digital printer such as a thermal, inkjet, electrophotographic, or silver halide printer. These printed sheets serve to wrap the cover half to form covers for the album and also serve to create the hinge in the cover. As can be seen in FIG. 4b, the cover half is made up of two parts, a cover section 43 and a fastening section 45. The fastening section 45 has holes 33. When the fabric sheets are applied to the cover section 43 and the fastening section 45, the fabric joins the two pieces, making the completed cover and creating a hinge between the two sections made out of fabric. This allows the cover to bend such that the fasteners are not seen from the outside of the book (see FIG. 7).

The media sheets preferably have inkjet receiving chemistry in or on the sheets. The chemistry may be applied to the fibers before making the fabric, or applied to the formed fabric. Some inkjet receiving chemistries include fluorochemicals, silicones, resin-based finishes, waxes, wax-metal emulsions, organometallic complexes, ionic (cationic or anionic) materials, and combinations thereof. It is believed that the repellant properties of the repellant finish chemicals help prevent the colorant from being absorbed into the textile, and facilitates allowing the colorant to fill the entire intended zone for the colorant. Details about some inkjet receiving chemistries may be found in U.S. Pat. Nos. 6,936,076 and 6,749,641.

The media sheets are preferably fabric, but may also be any printable stock, such as paper, cardboard, handmade paper, and plastic (such as vinyl). The fabric of the fabric media sheets can be a woven, knitted, non-woven material, tufted materials, or the like. Woven textiles can include, but are not limited to, satin, poplin, and crepe weave textiles. Knit textiles can include, but are not limited to, circular knit, warp knit, and warp knit with a microdenier face. The textile may be flat, or may exhibit a pile. Such textile materials can be formed of natural or synthetic fibers, such as polyester, nylon, wool, cotton, silk, polypropylene, rayon, lyocell, poly(lactide), acrylic, and the like, including textile materials containing mixtures and combinations of such natural and synthetic fibers.

Preferably, the fabric media sheets have an adhesive and a release liner on one side of the fabric. The non-adhesive side of the fabric sheet is the side printed on. The adhesive composition may contain epoxy, phenoformaldehyde, polyvinyl butyral, cyanoacrylates, rubber based adhesives, styrene/butadiene based adhesives, acrylics, and vinyl derivatives. The adhesive is preferably a permanent adhesive or an adhesive that is repositionable for a designated amount of time then becomes permanent.

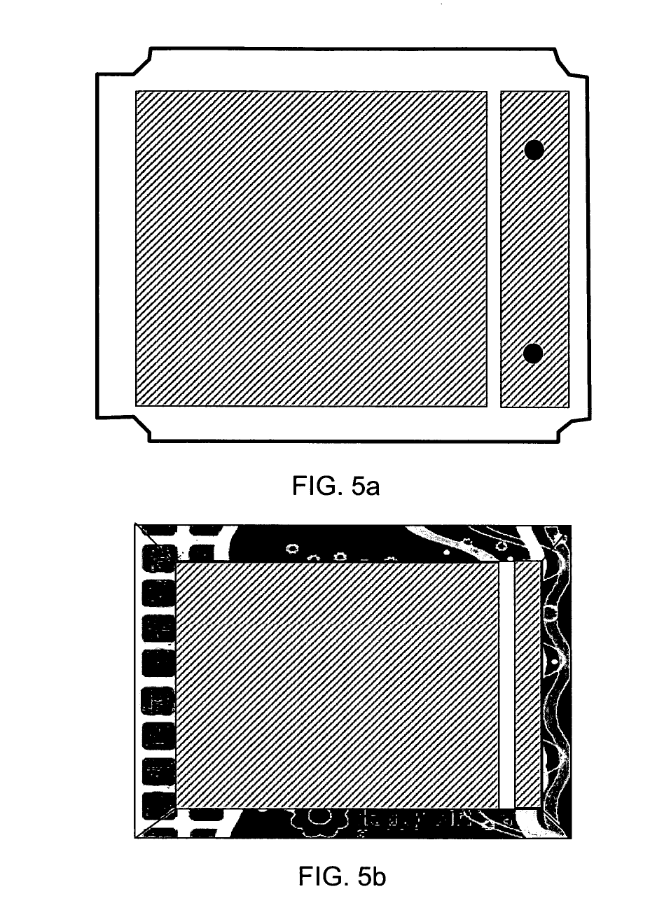

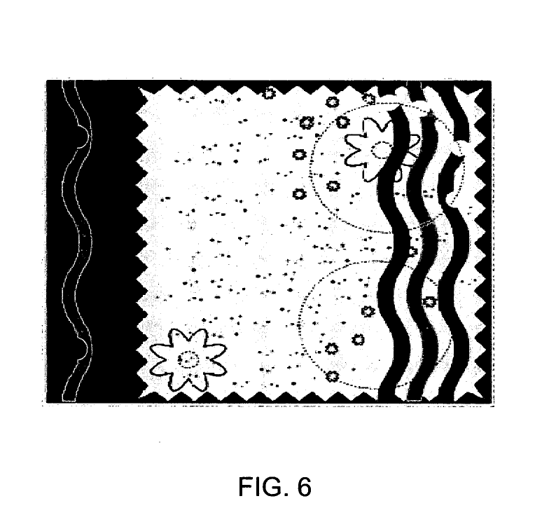

Once all of the fabric media sheets are printed, the memory album is assembled. The assembly begins with forming the covers for the album. FIG. 4a-c shows the components to form the front cover of the album, the outer front printed fabric sheet 31, the cover half 32 with holes 33, and the inner front printed fabric sheet 34. The user first cuts the printed fabric sheets 31 and 34 along the cutting lines 41 and 42. The user then removes the release liner of the outer front printed fabric media sheet 31 and applies the cover half 32 to the adhesive side of the outer front cover sheet as shown in FIG. 5a. The cutting line of the pattern of the front printed fabric sheet is configured such that the front printed sheet covers one side of the cover half completely and has flaps that extend out past the cover half. The flaps on the outer front printed sheet are then folded over the cover half as shown in FIG. 5b. This folding of the flaps ensures that the cover half is completely covered on all sides when completed, including the perimeter edges of the cover half. Next the trimmed inner front cover fabric sheet (shown as 34 in FIG. 4c before trimming) is applied to the inside of the cover half, covering the folded flaps of the outer front fabric sheet. The inner front cover fabric sheer cutting line is such that, when applied to the inner surface of the cover half (and the folded flaps from the outer printed sheet), the inner printed sheet completely covers the inner surface of the cover half and the flaps from the outer printed sheet. Once the inner front printed fabric sheet is applied, holes are formed in the inner and outer front fabric sheets that are aligned with the corresponding holes 33 of the cover half 32, shown in FIG. 6. The back cover for the back of the album is made using the same method as the front cover.

The middle sheets include fastener holes at an outer periphery for association with the fastener holes in the cover halves. After the covers are completed, the holes in the middle pages are aligned with the holes in the covers such that the covers will fold back onto the additional pages and the fasteners will not be seen from the outside of the album. Fasteners are placed through the holes in the middle pages and covers to secure the memory album together. This configuration may be seen in FIG. 7 showing a cross-section of a completed album with the covers 50 and 52 folded, middle pages 54, and a fastener 56 secured through the holes. The middle pages are preferably paper, more preferably are constructed from acid-free paper to protect any images printed on or attached to the pages. The middle pages may also be fabric, plastic, foam, or other material. The middle pages may be blank for the user to place additional graphics, images, and text on, or may be preprinted with decorations and/or text. In one embodiment, a story is preprinted on some of the middle pages. This story may relate to the theme picked by the user for the memory album and may be standard or personalized to the user.

Preferably the cover half is a piece of cardboard to give stiffness and rigidity to the assembled cover with the fabric. Some additional materials for the cover half may include corrugated cardboard, foam core, and poster board and may include batting to give the cover softness and loft. In the illustrated embodiment, the corners of the album, including both the front and back covers are rounded. The rounded corners reduce the chance of injury to an infant or small child since there are no sharp corners which can easily cut or poke.

The additional graphics may be placed by the user into the middle pages or mounted anywhere on the memory album. Preferably, the albums also features pocket pages, which may be located at the back of the album or strategically placed throughout the album. These pockets may be used to fold additional pictures or items. In the illustrated embodiment, the album has a generally rectangular shape. In other embodiments, however, the album can be shaped differently, such as, but not limited to, triangular, circular or an irregular shape.

What is claimed is:

1. A process for producing a personalized memory album comprising in order the steps of:
selecting image elements comprising a directed image, a personalized image, and personalized text, wherein the directed image is supplied by a software package;
uniting the selected image elements into a collected image file;
previewing the collected image file;
printing the collected image file onto the requisite number of media sheets; and,
assembling the printed media sheets and project base components into the personalized memory album.

2. The process of claim 1, wherein the media sheets comprise fabric.

3. The process of claim 1, wherein the software package comprises a plurality of themes and a plurality of patterns, each theme having at least one of the patterns associated with that particular theme.

4. The process of claim 1, wherein selecting the directed image comprises selecting one of the themes and selecting a pattern associated with the theme.

5. The process of claim 4, wherein the pattern comprises predetermined locations for the personalized image and personalized text and the step of uniting the selected image elements includes placing the personalized image and personalized text in the associated predetermined location.

6. The process of claim 4, wherein the pattern further comprising a cutting line.

7. The process of claim 1, wherein selecting personalized text includes selecting size and font of the text.

8. The process of claim 1, wherein the personalized image is provided by the user.

9. The process of claim 1, wherein the personalized image is supplied from the software package.

10. The process of claim 1, wherein selecting image elements further comprises selecting additional graphics.

11. The process of claim 10, wherein the additional graphics are applied to the printed media sheets.

12. The process of claim 1, wherein the collected image file is a portable document file.

13. The process of claim 1, wherein the media sheets comprise an inkjet receiving layer.

14. The process of claim 2, wherein the fabric media sheets comprise a knitted fabric.

15. The process of claim 2, wherein the fabric media sheets comprise a woven fabric.

16. The process of claim 2, wherein the fabric media sheets comprise an adhesive layer and release liner on one side of the fabric media sheet.

17. The process of claim 1, wherein the printing the collected image file comprises inkjet printing.

18. The process of claim 1, wherein the project base components comprise middle pages, fasteners, and cover halves.

19. The process of claim 18, wherein selecting image elements further comprises selecting additional graphics and the additional graphics are applied to the middle pages.

20. The process of claim 1; wherein assembling the printed media sheets and project base components comprises:
assembling a front cover;
assembling a back cover;
inserting middle pages between the front cover and back cover; and,
fastening the front cover, middle pages, and back cover together.

21. The process of claim 20, wherein the step of uniting the selected image elements further includes the collected image file having a front outer layout and a front inner layout, wherein the inner and outer front layouts are defined at their respective periphery by a cutting line and wherein the step of assembling the front cover further comprises;
cutting the media sheets on the cutting lines of the outer and inner front sheets;
applying the outer front sheet onto the front of a cover half;
folding areas of the outer front cover sheet that overhang the cover half onto the back of the cover half; and,
applying the inner front sheet onto the back of the cover half, wherein the applied inner front sheet covers the folded areas of the outer front cover sheet.

22. The process of claim 20, wherein the step of uniting the selected image elements further includes the collected image file having a back outer layout and a back inner layout, wherein the inner and outer back layouts are defined at their respective periphery by a cutting line and wherein the step of assembling the back cover further comprises;
cutting the media sheets on the cutting lines of the outer and inner back sheets;
applying the outer back sheet onto the back of a cover half;
folding areas of the outer back cover sheet that overhang the cover half onto the front of the cover half; and,
applying the inner back sheet onto the front of the cover half, wherein the applied inner back sheet covers the folded areas of the outer back cover sheet.

23. The process of claim 1, further comprising the steps of applying double sided clear adhesive tape to the assembled media sheets and applying beads to the adhesive tape.
